(19) United States
(12) Patent Application Publication
(10) Pub. No.: US 2012/0182244 A1
(43) Pub. Date: Jul. 19, 2012

(54) Integrated Multi-Display with Remote Programming and Viewing Capability

(75) Inventor: Thomas Arthur, Stuart, FL (US)

(73) Assignee: SystemsOne, LLC, Stuart, FL (US)

(21) Appl. No.: 13/429,552

(22) Filed: Mar. 26, 2012

Related U.S. Application Data
(63) Continuation-in-part of application No. 12/814,170, filed on Jun. 11, 2010.
(60) Provisional application No. 61/481,963, filed on May 3, 2011.

(51) Int. Cl. G06F 3/041; G09G 5/00

(52) U.S. Cl. 345/173; 345/156

(57) ABSTRACT

Embodiments of the present invention relate to systems and methods for providing remote assistance with a medical procedure by a technician via a remote device such as a laptop or tablet. Video output generated by medical devices and video captured by a camera, may be transmitted via a network and rendered on the remote device. Video may also be rendered a master display in a procedure room. Network connectivity data that controls access to the medical devices may be stored on servers located at a remote data center. The remote device may provide a remote technician with access to and control of the medical devices in order to assist in the procedure. The remote technician may be an expert on the medical equipment utilized by a physician during a medical procedure. Sterile coverings for a touchpad may be utilized.

This application is a continuation in part of U.S. Patent Publication No. 2010/0302156, which was filed Jun. 11, 2010, as patent application Ser. No. 12/814,170, and also claims priority to U.S. Patent Application 61/481,963 filed May 3, 2011. Each of these applications is hereby incorporated by reference in their entireties.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of multiple selectable systems integrated with display and control functions. In particular, the present invention relates to multiple selectable systems that permit a remote device to access the display and control functions of medical devices for use in the healthcare industry.

### BACKGROUND OF THE INVENTION

Medical images and cameras can be displayed on a single monitor, as described in U.S. patent application Ser. No. 11/413,232, which was filed by the present inventor on Apr. 27, 2006. Such medical imaging may include: fluoroscopic x-ray, ultrasound imaging, 3-dimensional mappings, computed tomography (CT) imaging, positron emission tomography (PET), magnetic resonance imaging (MRI), nuclear imaging, picture archiving and communication systems (PACS) imaging, anesthesia imaging, mammographic imaging, physiologic-monitor imaging, radiology imaging, and other hospital central processing unit (CPU) based imaging.

Physicians performing medical procedures often need real-time access to information from multiple instruments and systems. Traditionally, each of those systems had their own dedicated displays. The numerous monitors that are necessary to provide a physician with access to information from such systems require large, complex setups in spacious operating theaters and laboratories. Further restrictions include a limitation on the set of viewable displays and user interface options. In addition, such excessive equipment can be difficult to sterilize. A multi-display system, such as the system previously disclosed in U.S. Patent Publication No. 2010/0302156 which is incorporated by reference, may allow for improved data visualization by the physician.

Given the wide range of complex medical devices that are available, physicians can often benefit from the assistance of technicians who are specialists with respect to the devices. Implantable medical devices, such as pacemakers, often require programming and configuration by a technician at the time of implant or at a subsequent time in response to changes in the patient's condition. Unfortunately, however, it is not always practical or cost effective to have a technician physically available for every implantation procedure. In addition, the limitation on the number of displays and user interface options becomes more problematic when both a technician and a physician require simultaneous access and control. Maintaining a sterile procedure room also becomes challenging in the presence of a technician.

Nonetheless, technicians need access to the complicated medical CPU-driven devices in procedure rooms, such as pacemaker programmers, MRI consoles, CT scanners, oncology treatment devices and the like. The technician must be able to review certain medical images obtained from various sources such as radiology, ultrasounds, MRI, CT scans, pacemaker programmers and physiological monitors. At the same time, the technician must be able to observe the patient and medical staff who are present to perform the procedures. When a technician or physician is unable to attend a procedure, the operation is often rescheduled until a time when both technician and physician are available to be physically present. Otherwise, the procedure may be cancelled.

### SUMMARY OF THE INVENTION

According to an embodiment of the present invention, a system for participating in medical procedures may comprise a keyboard-video-mouse (KVM) controller operatively connected to a procedure-room device. The procedure-room device, which is located in a medical procedure room, may be capable of generating device-video output. The keyboard-video-mouse controller may be adapted to operatively connect to a network. The system may also comprise an encoder-decoder device operatively connected to a procedure-room camera to receive procedure-room video. The procedure-room camera is also located in the medical procedure room, and is capable of capturing the procedure-room video of the medical procedure room. The encoder-decoder device is operatively connected to the network. In addition, the system may comprise a database server in a first remote location. The database server may be adapted to operatively connect via the network to the keyboard-video-mouse controller and the encoder-decoder device. The database server may also be adapted to store network connectivity data and case data.

Further, the database server may be adapted to control access for a remote device to the procedure-room device and the procedure-room camera. The remote device may be located in a second remote location. It may also be adapted to communicate with the database server via the network. In addition, the remote device may be adapted to selectively display the device-video output and the procedure-room video. The remote device may be further adapted to control the procedure-room device and the procedure-room camera. As such, a remote technician utilizing the remote device can assist in a medical procedure.

In an embodiment, the system may further comprise a video processor operatively connected to the procedure-room device and the procedure-room camera. The video processor may be adapted to receive the device-video output and the procedure-room video.

The system, in an embodiment, may further comprise a second procedure-room device in the medical procedure room. This device may be capable of generating device-video output, and may be in operative communication with the keyboard-video-mouse controller. The remote device may be adapted to selectively display the device-video output generated by the second procedure-room device, whereby the remote technician utilizing the remote device can control the second procedure-room device in order to assist in a medical procedure.

In an embodiment, a second procedure-room device in the medical procedure room, which is capable of generating device-video output, may be in operative communication with a second keyboard-video-mouse controller. The second keyboard-video-mouse may be adapted to operatively connect to a network. The remote device may be adapted to selectively display the device-video output generated by the second procedure-room device, whereby the remote technician utilizing the remote device can control the second procedure-room device in order to assist in a medical procedure.

In some embodiments, the system may comprise a local computer in the medical procedure room that is adapted to operatively connect to the network. The local computer may be adapted to operatively connect to the procedure-room camera to control a feature of the procedure-room camera selected from a group of camera feature consisting of pan, tilt, and zoom.

In an embodiment, a master display in the medical procedure room may be adapted to operatively connect to the video processor. The master display may be adapted to selectively display the device-video output and the procedure-room video. The system may also comprise a touchpad in the medical procedure room that may be adapted to operatively connect to the video processor. The touchpad may be adapted to control the procedure-room device and the procedure-room camera.

The video processor may be adapted to combine the device-video output from the procedure-room device and the procedure-room video from the procedure-room camera for display on the master display based on commands received from the touchpad. The video processor may also display on the master display the combined video outputs. The remote device may be adapted to receive the combined video output via the network. In an embodiment, the remote device may be adapted to combine the device-video output from the procedure-room device and the procedure-room video from the procedure-room camera for display on the remote device.

The system, according to one embodiment, may further comprise a disposable, sterile plastic covering mounted on the touchpad. The master display may be capable of being operatively controlled by the touchpad and by the remote device.

In an embodiment, the system may comprise a procedure-room technician station located in the medical procedure room. The procedure-room technician station may have a technician display and an input device, whereby a procedure-room technician can view and control device-video output from the procedure-room device.

In various embodiments, the remote device may have a touch screen user interface and the remote device may be a tablet computer, a smartphone, a laptop or a personal computer.

In an embodiment, the system may further comprise a video broadcast server adapted to transmit video output via the network to the remote device. The video broadcast server may be hosted on a remote data center. In an embodiment, the first remote location that hosts the database server may be a remote data center operatively connected to the network.

The system of claim 1, wherein the procedure-room device is a programmer system analyzer adapted to program a pacemaker.

In an embodiment, the system may comprise a speaker and a microphone in the medical procedure room. These may be operatively connected to the network to transmit bi-directional audio between the remote device and the medical procedure room, whereby the remote technician can orally communicate with persons in the medical procedure room.

In an embodiment of the present, a method of enabling remote participation in medical procedures may comprise the step of receiving device-video outputs from procedure-room devices. Each of the procedure-room devices may generate device-video output. The outputs may be received by a video processor and a keyboard-video-mouse controller.

The method may also comprise the step of combining, via the video processor, at least two of the device-video outputs for display on a master display based on commands received from a touchpad. The video processor may be operatively connected to the touchpad. The master display and the touchpad may be located in the medical procedure room.

The method may comprise the step of selectively displaying on a master display, via the video processor, video outputs such as the device-video outputs received by the video processor and the combined video output. The method may also comprise transmitting the video outputs to a video broadcast server. The method may comprise storing network connectivity data in a database server that is adapted to be operatively connected via a network to the keyboard-video-mouse controller and the video processor. The database server may be located in a first remote location.

The method may comprise the step of operatively connecting a remote device to the keyboard-video-mouse controller and the video processor based on the network connectivity data. The remote device may be located in a second remote location. The method may comprise transmitting the video outputs to the remote device from the video broadcast server via the network. In addition, the method may comprise the step of controlling, via the remote device, at least one of the procedure-room devices, whereby a remote technician can assist in a medical procedure.

In an embodiment of the method, at least one of the procedure-room devices may be a programmer system analyzer adapted to control a pacemaker. At least one of the procedure-room devices may be a camera.

In an embodiment of the present invention, a system for participating in medical procedures may comprise a plurality of procedure-room devices in a medical procedure room capable of generating device-video output. The system may also comprise a keyboard-video-mouse controller operatively connected to at least one of the plurality of procedure-room devices. The keyboard-video-mouse may be adapted to operatively connect to a network. The system may comprise a video processor in the medical procedure room adapted to receive the device-video outputs generated by the plurality of procedure-room devices. The video processor may be adapted to combine device-video outputs from at least two of the plurality of procedure-room devices. The system may also comprise a database server in a first remote location adapted to operatively connect via the network to the plurality of procedure-room devices. The database server may be adapted to store network connectivity data and to control access by a remote device to the plurality of procedure-room devices. The remote device may be located in a second remote location and adapted to communicate with the database server via the network.

The remote device may be operatively connected via the network to the plurality of procedure-room devices and the video processor. The remote device may be further adapted to receive via the network video output such as the device-video outputs and combined-video output. The remote device may be adapted to selectively display the received video output. As such, a remote technician utilizing the remote device can operatively connect the remote device to the medical procedure room based on the network connectivity data and control at least one of the procedure-room devices in order to assist in a medical procedure.

In an embodiment of this system, the network may be the Internet and the remote device may be operatively connected to a video transport platform via the Internet connection. The remote device can operatively connect to the video processor and the plurality of procedure-room devices via the video transport platform.

In an embodiment, the video transport platform may be located in a data room in hospital. The medical procedure room may be located in the hospital. The video transport platform may be located in the medical procedure room. In an embodiment, the video processor may be operatively connected to a master display and a touchpad in the medical procedure room. The touchpad may control the video processor and the master display may render video output based on commands such as commands received from the touchpad and commands received from the remote device. The rendered video output may include the device-video outputs and/or the combined-video output.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 is a representation of an embodiment of the system of the present invention, including a flow chart illustrating steps performed by an embodiment of the remote device used by the technician, an architecture diagram of an embodiment of a multi-display system adaptable for use in a procedure-room, and architecture and database diagrams illustrating an embodiment of a cloud-based system for coordinating and facilitating communication between the technicians remote device and the multi-display system.

FIG. 2 is a block diagram illustrating the components of an embodiment of the present invention.

FIG. 3 is a block diagram illustrating multiple medical procedure-room devices connected to separate keyboard-video-mouse (KVM) controllers, in accordance with certain embodiments of the invention.

FIG. 4 is a block diagram illustrating multiple medical procedure-room devices connected to a single keyboard-video-mouse controller, in accordance with certain embodiments of the invention.

FIG. 5 is a block diagram illustrating video processor, in accordance with certain embodiments of the invention.

FIG. 6 is a block diagram illustrating a master display and a local touchpad, in accordance with certain embodiments of the invention.

FIGS. 7(a)-(d) illustrate various representations of an interface on the remote device for viewing and controlling multiple medical procedure-room devices and a procedure-room camera, in accordance with certain embodiments of the invention.

FIG. 8 is a flow chart illustrating steps performed by an embodiment of the remote device used by the technician, in accordance with certain embodiments of the invention.

FIG. 9 represents a screen shot of a procedure-room site selection screen on a remote device, in accordance with certain embodiments of the invention.

FIG. 10 represents a screen shot of a video view screen on a remote device illustrating video output from multiple medical procedure-room devices and a procedure-room camera, in accordance with certain embodiments of the invention.

FIG. 11 represents a screen shot of a programmer system analyzer (PSA) control screen on a remote device, in accordance with certain embodiments of the invention.

### DETAILED DESCRIPTION OF THE EMBODIMENTS

Reference will now be made in detail to the embodiments of the present invention, examples of which are illustrated in the accompanying drawings.

The present invention solves various problems with providing local and remote access to images from multiple devices used in the procedure room, which may need to be maintained in a sterile environment. While the local practitioner may be a professional who is conducting an operation in a procedure room, the remote technician may be an expert on the equipment utilized by the local practitioner. Embodiments may include medical equipment utilized by physicians during a medical procedure. However, other variations and embodiments will be apparent to those of ordinary skill in the art.

Certain embodiments of the presently disclosed invention may relate to the remote viewing of integrated medical images, camera-captured images/video, and output screens from medical devices. Such images may be viewed on a master display in the procedure room and/or a remote device such as a tablet, laptop or desktop computer. The tablet may be an Apple iPad platform, an Android platform or any other tablet-based platform. The presently disclosed invention may also comprise remote control capabilities, via the remote device, of the medical-based systems.

In an embodiment, the benefits of the present invention include providing access to medical procedures without the disadvantage of contamination of sterile equipment due excessive device controls and due to the physical attendance of numerous individuals, including the technician. Further, the present invention overcomes physical or networking restrictions against the integration of medical images, camera-captured images/video, and output screens from medical devices. For example, certain circumstances may result in restrictions on the number of displays that may be utilized or on the capabilities of user interfaces or controls that may be implemented.

The disclosed systems and methods may enable multiple data displays to be combined onto a single, preferably large scale, high definition monitor that is controllable and configurable by a physician through a touchpad that may be covered with a disposable, sterile plastic coating or covering. The result is a system that is both easier to use and more flexible. Moreover, the system may prevent overly crowded operating rooms and may reduce contamination of sterile equipment.

An embodiment of the present invention may also address the difficulty of providing a technician with access to a medical procedure when the physical appearance by the technician would be impossible or impractical due to the costs involved. If a medical device was manufactured in a foreign country, the expert technician may reside aboard. In that case, the travel cost may deter participation by the sought after expert. Moreover, the travel time involved may prevent a technician from presiding over an emergency procedure.

By integrating a remote access capability with a multi-display system, a technician in a different location can access the display of the multi-display system and remotely control certain devices integrated into that multi-display system. This allows the technician to assist the physician by performing tasks, such as pacemaker programming, without requiring the technician to be physically present in the procedure room along side with the doctor. This is made possible both because the technician has remote programming capability and the ability to view and analyze the data on the multi-display, which provides additional information regarding patient status.

In an embodiment, an application on a remote device, such as a laptop or tablet, may comprise a communications interface that conveys multiple video streams, camera control, remote CPU control of medical systems, and a network operations center (NOC) which stores information that is needed for each medical case. The tablet/laptop application may be implemented in an Apple iPad format, an Android format or any other tablet software, or on a laptop/desktop graphical user interface (GUI) solution. The cameras may be remotely controlled through such a GUI interface.

After logging into the remote application and obtaining pre-determined permissions, clinicians or technicians may utilize the application on a tablet/laptop/desktop to remotely view integrated medical images, such as radiology images, camera-captured images and images/information from medical CPU-based devices. Further, clinicians may utilize the application to control the aforementioned images, information and devices. Bi-directional audio may also be enabled during a medical procedure so that the physician and the technician may communicate. The remote clinician may further have pan/tilt/zoom (PTZ) control of the camera(s) via the application.

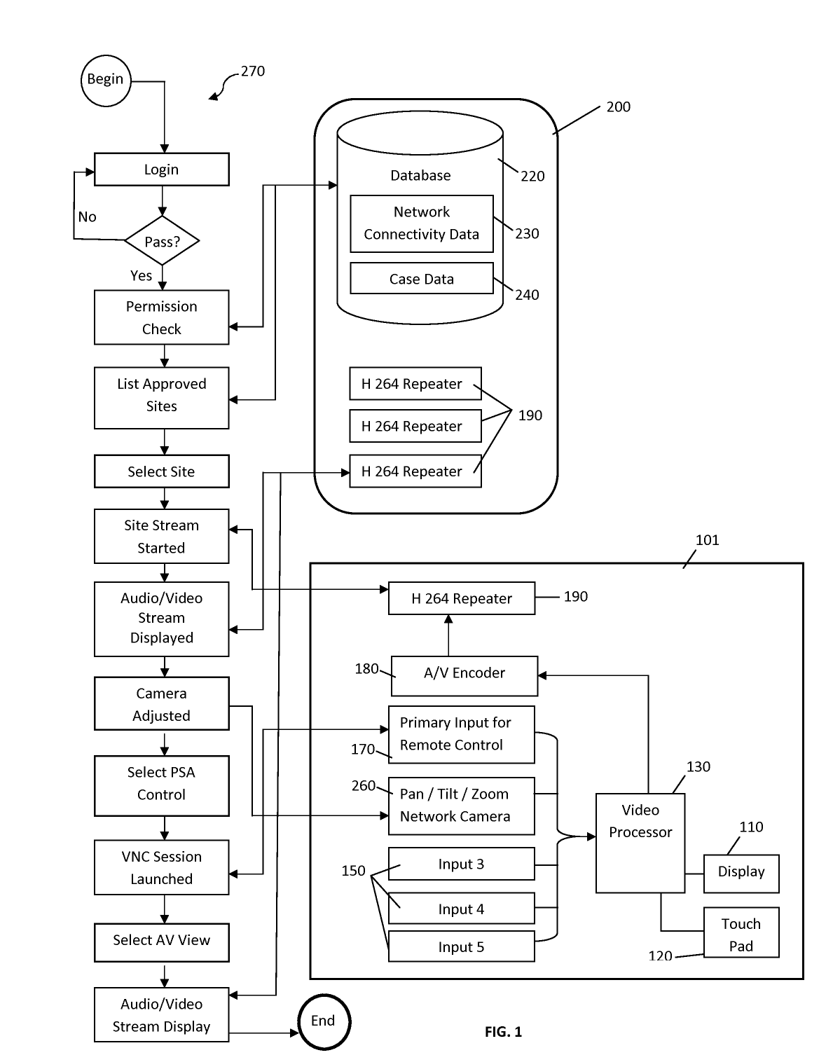

Referring to the embodiment illustrated in FIG. 1, a multi-display system 100 in a medical procedure room 101 may comprise a local master display 110 and a local touchpad 120, both of which may be connected to a video processor 130. The video processor 130 may receive input 140 from multiple procedure-room devices 150 such as a pan/tilt/zoom capable camera, a fluoroscopy device, an ultrasound device, and an electronic medical records system. It will be understood by those of skill in the art that virtually any device capable of generating a video output signal can be used as a procedure-room device 150 and that the present invention is not limited to any specific set of such devices.

Procedure-room devices 150 provide video signals to the video processor 130, as is further described below and in the incorporated references. The video processor 130 may be controlled in the procedure room by any number of user input devices. In the procedure room, the touchpad 120 is preferred because disposable sterile plastic covers 160 (not illustrated) can be used in connection with the touchpad 120 to assist in maintenance of a clean and sterile environment without the requirement of sterilizing input devices such as mice and keyboards. This allows the physician to control the devices 150 directly with less fear of compromising patient safety.

The touchpad 120 may be used both to control the operation of procedure-room devices 150 and to control how their output can be viewed on display 110. The display 110 is preferably a large-scale, high definition LCD, LED, or plasma display which is electrically connected to a video processor 130. The use of a large-scale, high definition display 110 allows the video processor 130 to combine the output of multiple procedure-room devices 150 onto a single display 110. Using the touchpad 120, a physician can adjust various settings including, without limitation: which procedure-room devices 150 will be displayed, how the output will be arranged, and the size of the various output windows. This not only reduces the number of display devices needed in the location at which the procedure is being performed, it also gives the doctor more flexibility in determining how information will be displayed than would otherwise be possible when multiple discrete displays are used.

Remote devices 170 (not illustrated) may be used by a technician to control the procedure-room devices 150 as well. A remote device 170 may have the capability to present multiple discrete displays, where each display may correspond to each procedure-room device 150. The remote device 170 may also have a keyboard and mouse or touchpad capable of controlling the procedure-room devices 150 as needed. The technician may have additional control capabilities over the procedure-room devices 150 that the physician lacks.

Duplicity of certain control capabilities is desirable for patient safety. The technician may review and corroborate certain procedures performed by the physician. In addition, the technician may select certain displays that may be useful to the physician. Through the use of bi-directional audio communication between the physician and the technician, the physician may request certain displays, thereby providing the physician with extra support when the physician is preoccupied during a procedure. Further, the technician may have additional control capabilities over the procedure-room devices 150 which may provide for the use of a simplified user interface on touchpad 120 without limiting the ability of the physician to access less-used features of procedure-room devices 150 when needed.

In an embodiment, certain procedure-room devices 150 may be complex or specialized such that the doctor can benefit from the assistance of a technician when using them. One example of such a device 150 would be a programmer system analyzer (PSA) such as is commonly used to configure a pacemaker prior to and after implantation. Many other complex devices 150 are known to those of skill in the art may also be used.

In an embodiment, a device 150 may have a display output that is controlled by a video processor 130. Device 150 may conveniently be controlled by touchpad 120, by its own integral controls (not illustrated) or by a procedure-room workstation (not shown), which may be utilized by a technician. In this way, a local technician may optionally be physically located in the procedure with the physician in order to assist in the use of the device 150. The present invention, however, extends that capability by allowing a remote technician to perform the same service by remote control.

In an embodiment, an encoder/decoder 180 may accept an output from video processor 130 in order to encode the output for transmission over a preferably wide area network, such as the Internet. The encoded data stream is then provided to repeater 190. Such repeaters 190 are configured to transmit the encoded data stream to remote data center 200 so that it avoids timing, buffering, and skipping problems. The location of remote data center 200 may be any arbitrary location. The remote data center 200 may be a cloud-based provider. While the remote data center 200 could be on the same local network as the multi-display system 100, it may preferably be located in a separate location in communication with the multi-display system 100 via the Internet.

In an embodiment, the remote data center 200 comprises video broadcast servers 210 and a database server 220. It will be understood by those of skill in the art that video broadcast servers 210, or video transport platforms 210, and a database server 220 may or may not be on shared hardware or even located at the same facility. It will further be understood by those of skill in the art that a database server 210 may comprise multiple servers, each adapted to store a different type of information. In this way, for example, network connectivity data 230 can be maintained in one database, while patient-specific case data is stored on another database, such as a database maintained by the manufacturer of a procedure-room device 150. This allows for differing levels of security protections for patient-specific data and network connectivity data 230, which can be important in protecting patient privacy and compliance with medical records laws, standards, and regulations.

Network connectivity data 230 may comprise fields necessary to connect a technician to a particular multi-display system 100. Through well understood log-on and security validation procedures, network connectivity data 230 can be used to control access by technicians who are authorized to assist with procedures in any given location having a multi-display system 100. Network connectivity data 230 may include: User name, Password, User Status, Site Name, Site Account Number, Site IP Address, Site Authentication, Site Status, Repeater Cloud Authentication, Repeater Cloud Status, Connection Start Time, Connection End Time, and/or User/Site Permissions.

Case data 240 may maintain data specific to a particular procedure performed on a particular patient. This provides a record of the personnel involved in the procedure, certain information relating to the patient, and information regarding the steps performed and/or setting used or changed during the procedure. Case data 240 may include: Account Number, Account Name, Hospital Name, Hospital Address, Hospital Phone Number, Implanting Physician Name, Purchase Order Number, Patient Name, Patient Address, Patient Phone Number, Patient SSN, Implant Device Model, and/or Implant Device Serial Number.

In an embodiment, a remote application 250 run on a remote device 170 may be used by a remote technician to assist in a procedure. A remote application 250 is a software application capable of connecting to both data center 200 and multi-display system 100 through a network, such as the Internet. Any number of network-capable remote devices 170 may be used including, without limitation, personal computers, laptops, or smartphones in certain applications. One such suitable device 170 is a tablet, such as an iPad. Such remote devices 170 offer high-quality display capabilities and convenient touch-based user interfaces.

Using remote application 250, a remote technician will log-on and have permissions validated by connecting with the remote data center 200, which will compare the credentials of a technician to the records in network connectivity data 230. The technician may be presented with a list of procedures in which he or she is authorized to participate. Selecting a particular procedure will cause the remote application 250 to connect to a video broadcast server 210. The remote application 250 may display the same information as appears on the display 110 in the procedure room, thereby allowing the technician to see the same information as is being displayed to the physician.

In addition to connecting to a display stream through data center 200, the remote application 250 may also connect directly to certain procedure-room devices 150. In such an embodiment, the technician will be able to both view the information on display 110 and control certain procedure-room devices 150 through a user interface provided by remote application 200. For example, the technician might access pan/tilt/zoom controls on a camera 260 in the procedure room in order to get a better view of the implantation site. The technician may utilize a set of programming controls in the remote application 250 to assist the physician in operating the procedure-room room devices 150, such as a pacemaker programmer. Communication between the physician and the technician can occur through any variety of means known in the art including chat technology, video conferencing, IP telephony, or a standard telephone connection.

Procedure specific case data 240 may be initially specified either before the procedure begins or by the multi-display system 100. More detailed information regarding the procedure, such as the settings used, can be updated either by the multi-display system 100 or the remote application 250.

As a result, greater flexibility and ease of use for the physician is achieved. Furthermore, a benefit is provided by allowing a technician to assist the physician without actually being present in the procedure room. Appropriate means of programming remote application 250 and the components in a data center 200 are known to those of ordinary skill in the art and will be apparent in light of the foregoing description.

In addition to the previously described system, a method of remotely controlling medical devices is also herein disclosed. In an embodiment, the method may comprise the steps of providing a multi-display system 100 with a touchpad 120, a video processor 130, procedure-room devices 150, and a master display 110. The video processor 130 may be connected to the display 110, the procedure-room devices 150, and a repeater 190 capable of transmitting the displayed information over a network. A further step of the method may comprise providing a cloud-based data center having video broadcast servers 210 and a database server 220 housing network connectivity data 230. A further step of the method may comprise providing a remote device 170 capable of communicating with both the data center 200 and the procedure-room devices 150, whereby a remote technician may access a video display from a multi-display system 100, and control one or more procedure-room devices 150.

In an embodiment, a master display 110 and a touchpad in the procedure room are not used. Rather, the remote device 170 displays any images generated by the procedure-room devices 150, and the remote device 170 may also control the video processor 130. Accordingly, the remote device 170 has the capabilities to combine any of the images and render a multiple data display on the screen of the remote device 170.

The representation of the embodiment of the present invention shown in FIG. 1 illustrates how certain components interact. The remote application 250 which runs on a remote device 170 may provide for the steps shown in the flow chart 270. These steps may be performed by an embodiment of the remote device used by the remote technician. FIG. 1 further shows the architecture diagram of an embodiment of a multi-display system 100 adaptable for use in the procedure-room. In addition, FIG. 1 illustrates the architecture and database diagrams for an embodiment of a cloud-based remote date center 200 for coordinating and facilitating communication between the remote application 250 on the technician remote device 170 and the multi-display system 100 in the procedure-room.

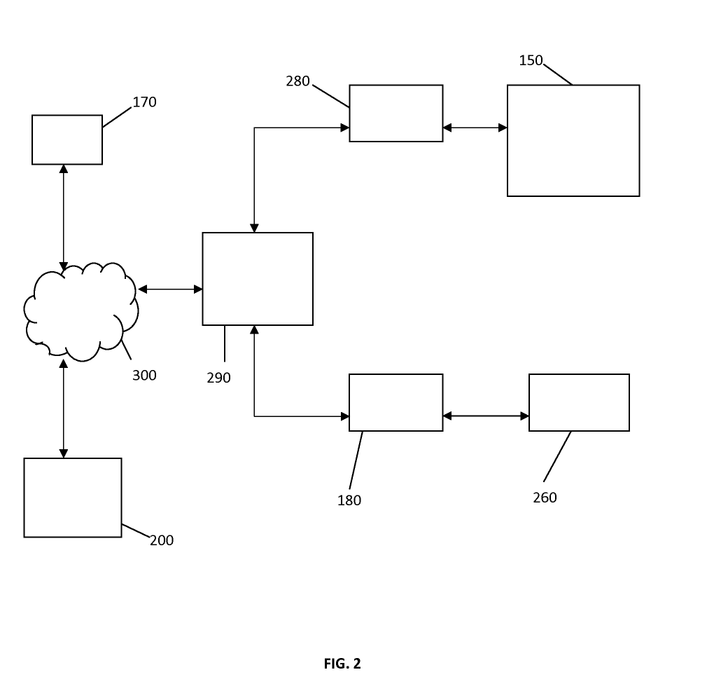

FIG. 2 shows the components of a certain embodiment of the present invention. A procedure-room device 150 is connected to a keyboard-video-mouse (KVM) controller/device 280, which is connected to a router 290 that is connected to a network 300 such as the Internet. The KVM device 280 may be a KVM-over-IP (KVMoIP) device. A procedure-room camera 260 may capture images or video from the procedure-room. The video/images captured by the camera 260 may be sent to the encoder/decoder 180, which is also connected to the router 290. Video from the procedure-room device 150 and the camera 260 may be transmitted across the network 300 via the router 290. A remote device 170 may receive and render the transmitted video. The video may be transmitted to the remote device 170 via the network 300 directly from the router 290. Alternatively, the video may be transmitted to the remote device 170 via the network 300 after it re-directed from the router 290 through the remote data center 200 for security purposes.

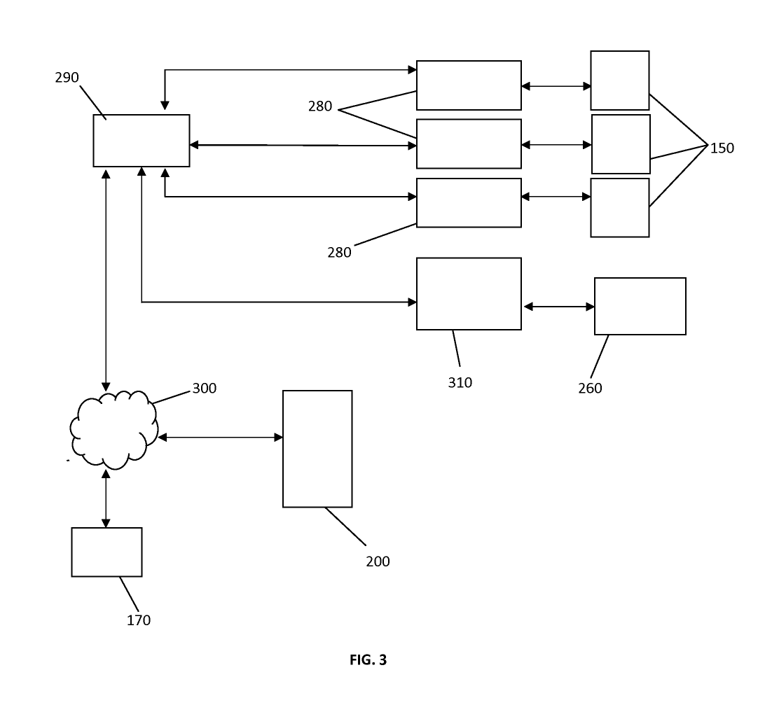

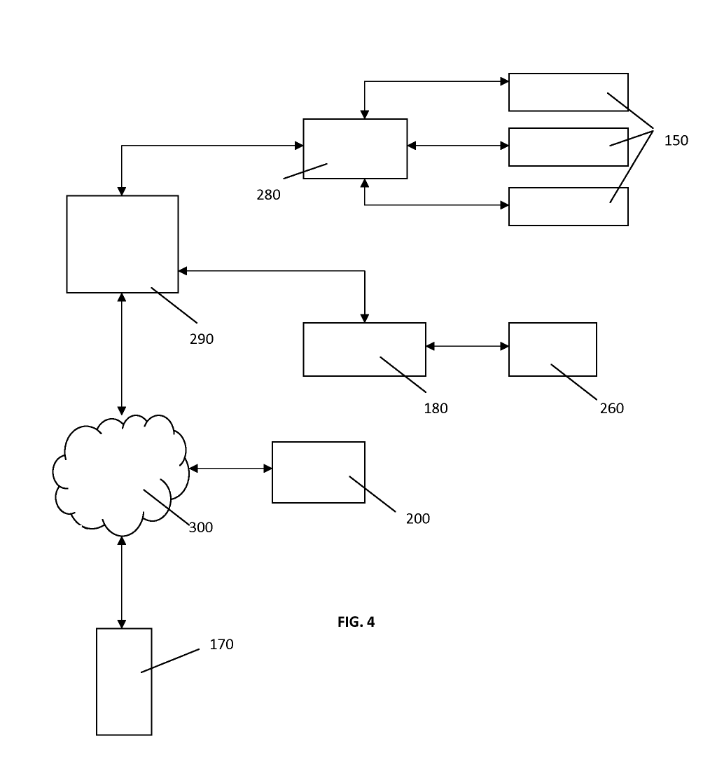

FIG. 3 illustrates that multiple procedure-room devices 150 may be utilized, each of which may simultaneously transmit video to the remote device 170. The multiple procedure-room devices 150 may be connected to corresponding KVM devices 280. The procedure-room camera 260 may be connected to a local computer 310 in the procedure-room. As shown in FIG. 4, the procedure-room camera 260 may be connected directly to the encoder/decoder 180 in the procedure-room. The multiple medical procedure-room devices 150 may be connected to a single KVM device 280, which is connected to the router 290.

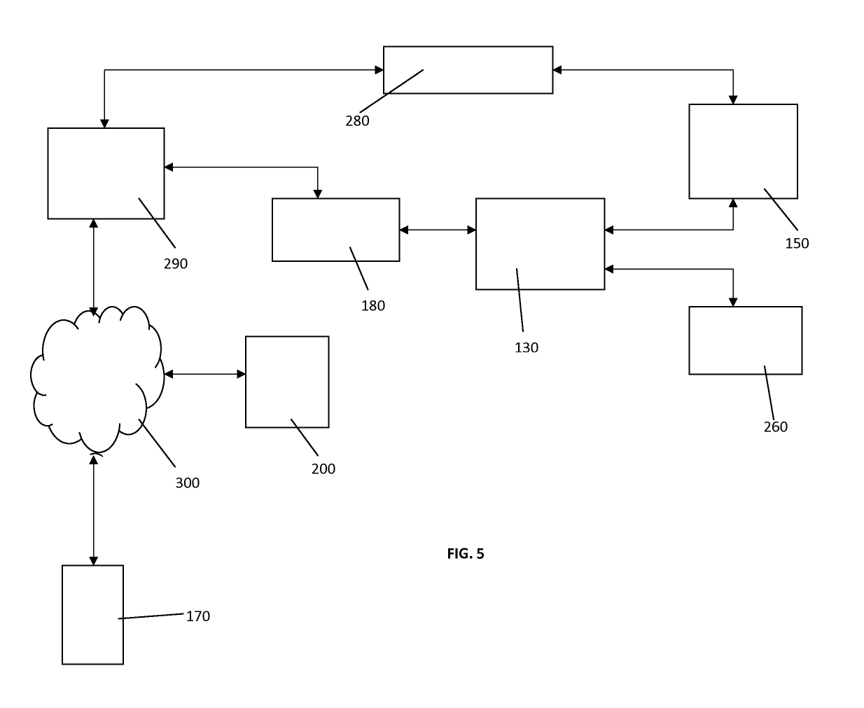

In the embodiment shown in FIG. 5, a video processor 130 may be utilized to transmit video from a procedure-room device 150 and a procedure-room camera 260. The video processor 130 is connected to the encoder/decoder 180. While a remote technician controls the procedure-room device 150, video from the procedure-room camera 260 may be transmitted via the video processor 130. While a remote technician controls the procedure-room camera 260, video from the procedure-room device 150 may be transmitted via the video processor 130.

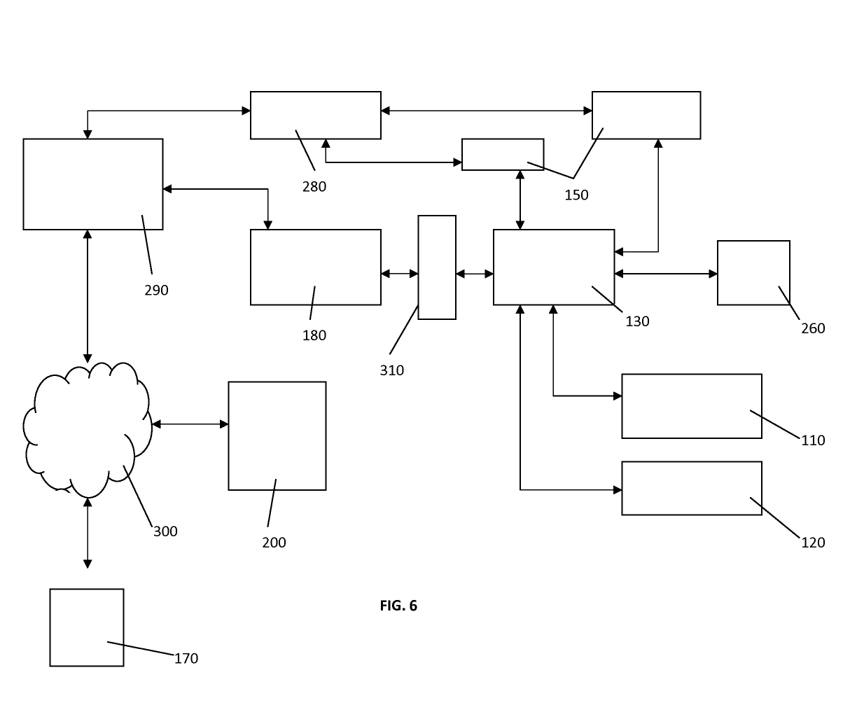

FIG. 6 illustrates an embodiment where the video processor 130 may also be connected to a local master display 110 and a local touchpad 120 in the procedure-room. The video processor 130 may be connected to second procedure-room device 150. In addition, the video processor 130 may be connected to a local computer 310, which may be connected to an encoder/decoder 180.

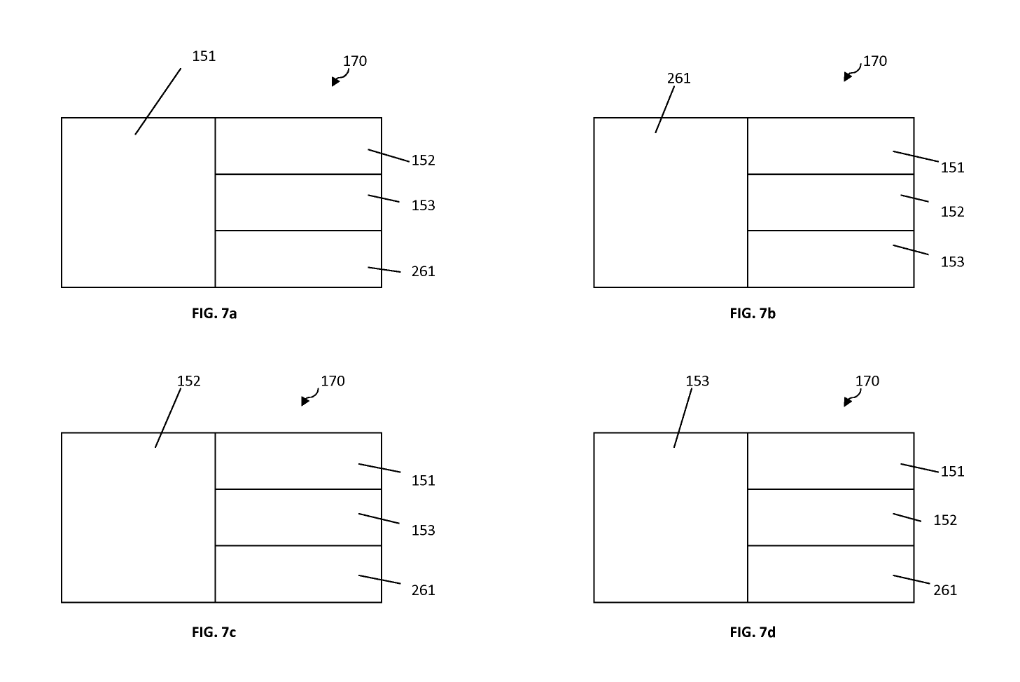

FIGS. 7(a)-(d) illustrate examples of the combinations of video that may be rendered on the remote device 170. FIG. 7(a) shows that device-video outputs 152 and 153 from two procedure-room devices 150 (not shown) and video 261 from a procedure-room camera 260 (not shown) may be displayed in small windows on the right-side of the screen of the remote device 170 while another procedure-room device 150 is being controlled by the remote technician. Video 151 from the procedure-room device 150 that is being controlled may be displayed in a large window on the screen of the remote device 170. FIG. 7(b) illustrates that the procedure-room camera 260 may be controlled while the procedure-room video 261 is displayed in a larger window on the screen of the remote device 170. Device-video outputs 151, 152 and 153 from the three procedure-room devices 150 may be simultaneously displayed in small windows on the screen of the remote device 170. FIGS. 7(c) and (d) show device-video outputs 152 and 153 in a larger window, respectively, while the corresponding procedure-room devices 150 are being controlled.

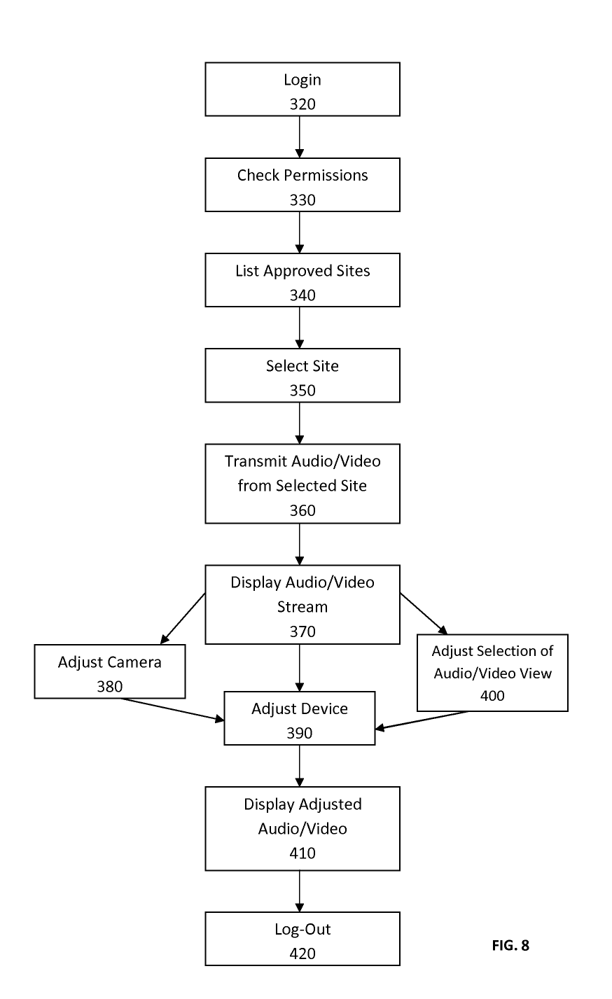

FIG. 8 shows an embodiment of the flow chart 270 for a remote device 170, which includes the following steps: login 320, check permissions 330, list approved procedure-room sites 340, select a procedure-room site 350, transmit audio/video from the selected procedure-room site 360, display the video 370, adjust a procedure-room camera 380, adjust a procedure-room device 390, adjust the selection of the displayed video 400, display/render the video after adjustments 410, and logout 420.

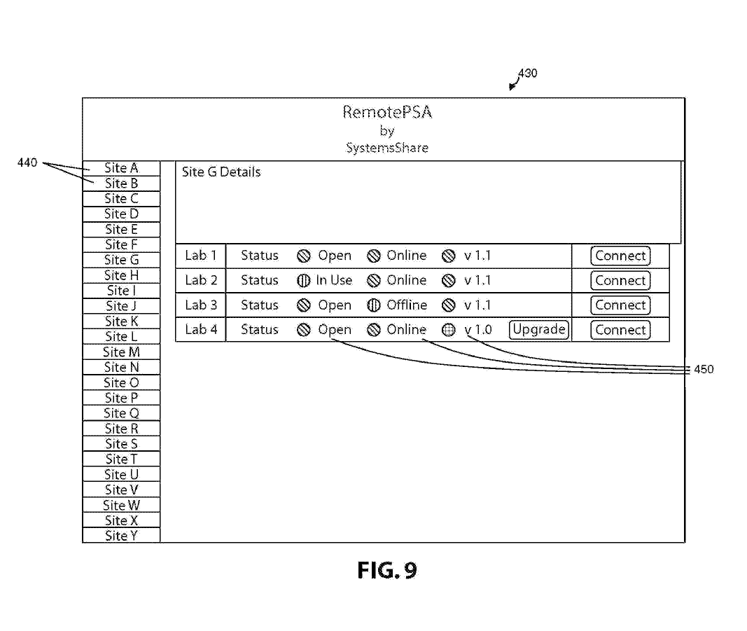

FIG. 9 represents an example of a screen shot of a procedure-room site selection screen 430 on a remote device 170 (not shown). This screen 430 is utilized for the step 340 (not shown) of listing links 440 to approved procedure-room sites and the step 350 (not shown) of selecting a procedure-room site. For an approved procedure-room site, the screen may list the real-time status information 450 about labs located at the site. Such status information 450 may indicate: the software/equipment version implemented at the lab, whether the lab is online or offline, and whether the lab is open or in-use.

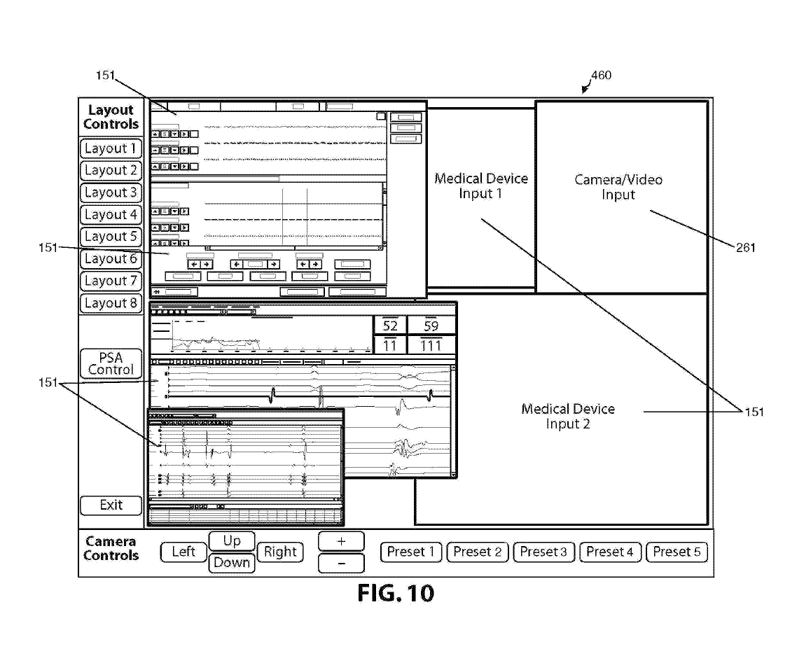

FIG. 10 represents an example of a screen shot of a video view screen 460 on a remote device 170 (not shown). This screen 460 illustrates video output 151 from procedure-room devices 150 (not shown) and procedure-room video 261 from a procedure-room camera 260 (not shown). This screen may be utilized for the following steps (not shown): display the video 370, adjust a procedure-room camera 380, adjust a procedure-room device 390, adjust the selection of the displayed video 400, display the video after adjustments 410, and logout 420. Such steps may be performed via controls, including: layout controls, camera controls (such as zoom-in, zoom-out and camera-direction buttons and preset buttons), procedure-room device controls (such as a PSA control), and an exit button.

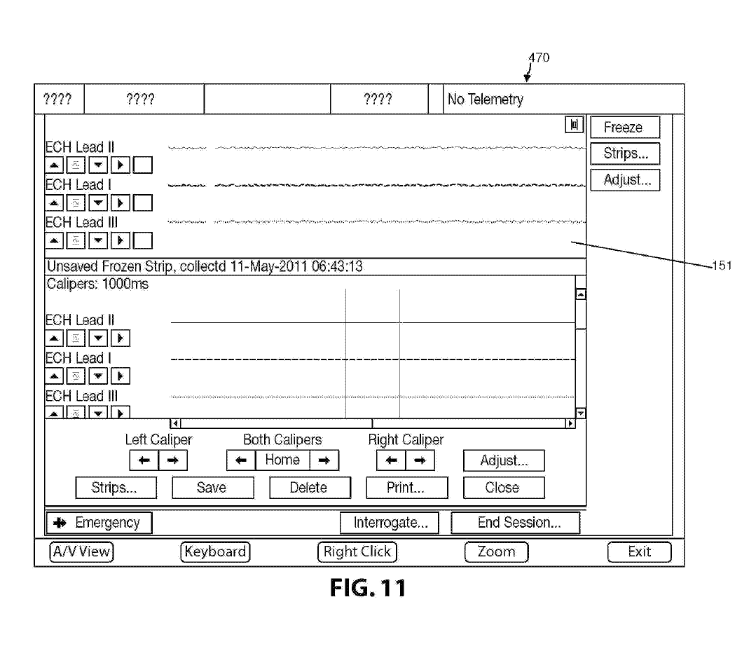

FIG. 11 represents a screen shot of a PSA control screen 470 on a remote device 170 (not shown). This screen 470 illustrates video output 151 from a procedure-room device 150, i.e. the PSA, (not shown). This screen 470 is utilized for the step 370 (not shown) of displaying the video generated by the PSA and the step 390 (not shown) of adjusting a procedure-room device. The video output 151 may be controlled, edited, saved, deleted, printed, adjusted or freeze-framed via procedure-room device controls.

Although some of the drawings illustrate a number of operations in a particular order, operations which are not order-dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof. The term “adapted” when used in this application shall mean programmed, configured, dimensioned, oriented and arranged as appropriate to the purpose or function described.

While the invention has been particularly shown and described with reference to an embodiment thereof, it will be understood by those skilled in the art that various changes in form and details may be made therein without departing from the spirit and scope of the invention. Other variations and embodiments will be apparent to those of ordinary skill in the art, all of which are within the scope of the present invention.

What is claimed is:

1. A system for participating in medical procedures, comprising:
a keyboard-video-mouse controller operatively connected to a procedure-room device, the procedure-room device in a medical procedure room capable of generating device-video output, the keyboard-video-mouse controller adapted to operatively connect to a network;
an encoder-decoder device operatively connected to a procedure-room camera to receive procedure-room video, the procedure-room camera being located in the medical procedure room and capable of capturing the procedure-room video of the medical procedure room, the encoder-decoder device operatively connected to the network; and,
a database server in a first remote location adapted to operatively connect via the network to the keyboard-video-mouse controller and the encoder-decoder device, the database server adapted to store network connectivity data and case data,
the database server further adapted to control access for a remote device to the procedure-room device and the procedure-room camera, the remote device being located in a second remote location and adapted to communicate with the database server via the network, the remote device further adapted to selectively display the device-video output and the procedure-room video, the remote device further adapted to control the procedure-room device and the procedure-room camera,
whereby a remote technician utilizing the remote device can assist in a medical procedure.

2. The system of claim 1, further comprising:
a video processor operatively connected to the procedure-room device and the procedure-room camera, the video processor adapted to receive the device-video output and the procedure-room video.

3. The system of claim 1, further comprising:
a second procedure-room device in the medical procedure room capable of generating device-video output, the second procedure-room device in operative communication with the keyboard-video-mouse controller, wherein the remote device is adapted to selectively display the device-video output generated by the second procedure-room device, whereby the remote technician utilizing the remote device can control the second procedure-room device in order to assist in a medical procedure.

4. The system of claim 1, further comprising:
a second procedure-room device in the medical procedure room capable of generating device-video output, the second procedure-room device in operative communication with a second keyboard-video-mouse controller, wherein the second keyboard-video-mouse controller is adapted to operatively connect to a network, wherein the remote device is adapted to selectively display the device-video output generated by the second procedure-room device, whereby the remote technician utilizing the remote device can control the second procedure-room device in order to assist in a medical procedure.

5. The system of claim 1, further comprising:
a local computer in the medical procedure room adapted to operatively connect to the network, the local computer adapted to operatively connect to the procedure-room camera to control a feature of the procedure-room camera selected from a group of camera feature consisting of pan, tilt, and zoom.

6. The system of claim 2, further comprising:
a master display in the medical procedure room adapted to operatively connect to the video processor, the master display is adapted to selectively display the device-video output and the procedure-room video.

7. The system of claim 6, further comprising:
a touchpad in the medical procedure room adapted to operatively connect to the video processor, the touchpad is adapted to control the procedure-room device and the procedure-room camera.

8. The system of claim 7, wherein the video processor is adapted to:
combine the device-video output from the procedure-room device and the procedure-room video from the procedure-room camera for display on the master display based on commands received from the touchpad; and,
display on the master display the combined video outputs.

9. The system of claim 8, wherein the remote device is adapted to receive the combined video output via the network.

10. The system of claim 1, wherein the remote device is adapted to combine the device-video output from the procedure-room device and the procedure-room video from the procedure-room camera for display on the remote device.

11. The system of claim 7, further comprising:
a disposable, sterile plastic covering mounted on the touchpad.

12. The system of claim 7, wherein the master display is capable of being operatively controlled by the touchpad and by the remote device.

13. The system of claim 1, further comprising:
a procedure-room technician station located in the medical procedure room, the procedure-room technician station having a technician display and an input device, whereby a procedure-room technician can view and control device-video output from the procedure-room device.

14. The system of claim 1, wherein the remote device has a touch screen user interface.

15. The system of claim 1, wherein the remote device is a tablet computer.

16. The system of claim 1, wherein the remote device is a smartphone.

17. The system of claim 1, wherein the remote device is a personal computer.

18. The system of claim 1, further comprising:
a video broadcast server adapted to transmit video output via the network to the remote device, the video broadcast server hosted on a remote data center.

19. The system of claim 1, wherein the first remote location is a remote data center operatively connected to the network.

20. The system of claim 1, wherein the procedure-room device is a programmer system analyzer adapted to program a pacemaker.

21. The system of claim 1, further comprising:
a speaker and a microphone in the medical procedure room operatively connected to the network to transmit bi-directional audio between the remote device and the medical procedure room, whereby the remote technician can orally communicate with persons in the medical procedure room.

22. A method of enabling remote participation in medical procedures, comprising the steps of:
receiving device-video outputs from a plurality of procedure-room devices, wherein each of the plurality of procedure-room devices generate device-video output, wherein the device-video outputs are received by a video processor and a keyboard-video-mouse controller;
combining, via the video processor, at least two of the device-video outputs for display on a master display based on commands received from a touchpad, wherein the video processor is operatively connected to the touchpad, wherein the master display and the touchpad are located in the medical procedure room;
selectively displaying on a master display, via the video processor, video outputs selected from a group consisting of the device-video outputs received by the video processor and the combined video output;
transmitting the video outputs to a video broadcast server;
storing network connectivity data in a database server adapted to be operatively connected via a network to the keyboard-video-mouse controller and the video processor, wherein the database server is located in a first remote location;
operatively connecting a remote device to the keyboard-video-mouse controller and the video processor based on the network connectivity data, wherein the remote device is located in a second remote location;
transmitting the video outputs to the remote device from the video broadcast server via the network; and,
controlling, via the remote device, at least one of the plurality of procedure-room devices, whereby a remote technician can assist in a medical procedure.

23. The method of claim 22, wherein at least one of the plurality of procedure-room devices is a programmer system analyzer adapted to control a pacemaker.

24. The method of claim 22, wherein at least one of the plurality of procedure-room devices is a camera.

25. A system for participating in medical procedures, comprising:
a plurality of procedure-room devices in a medical procedure room capable of generating device-video output;
a keyboard-video-mouse controller operatively connected to at least one of the plurality of procedure-room devices, the keyboard-video-mouse controller adapted to operatively connect to a network;
a video processor in the medical procedure room adapted to receive the device-video outputs generated by the plurality of procedure-room devices, the video processor adapted to combine device-video outputs from at least two of the plurality of procedure-room devices; and,
a database server in a first remote location adapted to operatively connect via the network to the plurality of procedure-room devices, the database server adapted to store network connectivity data, the database server further adapted to control access by a remote device to the plurality of procedure-room devices, the remote device being located in a second remote location and adapted to communicate with the database server via the network,
the remote device being operatively connected via the network to the plurality of procedure-room devices and the video processor, the remote device further adapted to receive via the network video output selected from a group consisting of the device-video outputs and combined-video output, wherein the remote device is adapted to selectively display the received video output,
whereby a remote technician utilizing the remote device can operatively connect the remote device to the medical procedure room based on the network connectivity data and can control at least one of the plurality of procedure-room devices in order to assist in a medical procedure.

26. The system of claim 25, wherein the network is the Internet and the remote device is operatively connected to a video transport platform via the Internet connection, whereby the remote device can operatively connect to the video processor and the plurality of procedure-room devices via the video transport platform.

27. The system of claim 25, wherein the video transport platform is located in a data room in hospital, wherein the medical procedure room is located in the hospital.

28. The system of claim 25, wherein the video transport platform is located in the medical procedure room.

29. The system of claim 25, wherein the video processor is operatively connected to a master display and a touchpad in the medical procedure room, wherein the touchpad controls the video processor, wherein the master display renders video output based on commands selected from a group consisting of commands received from the touchpad and commands received from the remote device, wherein the rendered video output is selected from a group consisting of the device-video outputs and the combined-video output.
